(19) United States
(12) Patent Application Publication
(10) Pub. No.: US 2026/0154309 A1
(43) Pub. Date: Jun. 4, 2026

(54) METHOD AND SYSTEM FOR PROCESSING NATURAL LANGUAGE QUERIES FOR GENERATING ANALYTICAL INSIGHTS

(71) Applicant: LTI Mindtree Ltd, Mumbai (IN)

(72) Inventors: Sreetha S, Mumbai (IN); Pradeep T, Mumbai (IN); Baranitharan Selvasundaram, Mumbai (IN); Sreelakshmi K, Mumbai (IN)

(21) Appl. No.: 19/062,038

(22) Filed: Feb. 25, 2025

(30) Foreign Application Priority Data
Dec. 3, 2024 (IN) 202421095222

(51) Int. Cl. G06F 16/334

(52) U.S. Cl. CPC G06F 16/3344

(57) ABSTRACT

A method and system for processing natural language queries is disclosed. A natural language query is received from a user during a session. Contextual information associated with the natural language query is retrieved by applying a retrieval-augmented-generation (RAG) model to the query to identify relevant metadata entities, and by accessing a session memory module to obtain related previous queries and corresponding insights from the current session. A large language model (LLM) processes the natural language query based on the retrieved contextual information to generate a analytical query. The analytical query is executed against a data source to generate analytical insights. The session memory module is updated with the natural language query and the analytical insight, and is provided to the user via the display unit in one or more user desired formats.

### FIELD

Various embodiments of the present disclosure generally relate to natural language queries. More particularly, the disclosure relates to a method and system for processing natural language queries using a retrieval-augmented-generation (RAG) model and a large language model (LLM) for generating analytical insights.

### BACKGROUND

Traditional business analytics systems rely on structured query languages and predefined formats for data retrieval and analysis. Such systems require users to formulate queries according to specific syntactical rules, often necessitating technical expertise in query languages and deep understanding of underlying data structures.

The emergence of natural language interfaces has introduced capabilities for processing unstructured queries. These implementations typically convert natural language inputs into structured queries through pattern matching and keyword identification. However, such systems may process queries in isolation, without incorporating broader conversational context.

Recent advancements in conversational systems have enabled basic context retention through memory modules. These approaches maintain user interaction history and leverage it for personalizing responses. While these systems enhance user experience through personalization, they primarily focus on general conversational engagement rather than specialized business analytics.

Vector-based retrieval systems represent another advancement in query processing. Such systems encode queries and data into high-dimensional vector spaces, enabling semantic matching between user inputs and stored information. However, these implementations may face challenges in maintaining contextual continuity across sequential business queries.

Various implementations combine natural language processing with business analytics capabilities. These systems attempt to bridge the gap between conversational interfaces and data analysis by interpreting business queries expressed in natural language. The interpretation of contextual references across sequential business queries presents unique technical considerations.

Certain systems implement session management mechanisms for tracking user interactions. Such approaches utilize conversation history in conjunction with data processing capabilities, contributing to the evolution of business analytics implementations.

Technological advances in query processing continue to develop, particularly in areas relating to contextual interpretation and automated query enhancement. Such advancements may further enable systems to process complex, context-dependent queries while maintaining contextual continuity across user interactions.

### SUMMARY

Disclosed embodiments relate to systems and methods for processing a natural language query received from a user during a current session. Contextual information associated with the natural language query is retrieved by applying a retrieval-augmented-generation (RAG) model to the natural language query to identify relevant metadata entities. Retrieval of the contextual information is also performed by accessing a session memory module to obtain related previous queries and corresponding insights from the current session. A large language model (LLM) processes the natural language query based on the retrieved contextual information to generate an analytical query. The analytical query is executed against a data source to generate an analytical insight. The session memory module is updated with the natural language query and the analytical insight, and the analytical insight is provided to the user.

These and other features and advantages of the present disclosure may be appreciated from a review of the following detailed description of the present disclosure, along with the accompanying figures in which like reference numerals refer to like parts throughout.

### BRIEF DESCRIPTION OF THE FIGURES

FIG. 1 is a diagram that illustrates an exemplary environment within which various embodiments of the present disclosure may function.

FIG. 2 is a diagram that illustrates the system for processing natural language queries, in accordance with an embodiment of the disclosure.

FIG. 3 is an exemplary diagram that illustrates the framework of the system for processing natural language queries, in accordance with an embodiment of the disclosure.

FIG. 4 is a diagram that illustrates a flow chart for a method for processing natural language queries, in accordance with an embodiment of the disclosure.

### DESCRIPTION

Pursuant to various embodiments, the method and system processes a natural language query received from a user in a current session. Contextual information associated with the natural language query is retrieved by applying the RAG model to the natural language query to identify relevant metadata entities. Retrieval of the contextual information is also performed by accessing a session memory module to obtain related previous queries and corresponding insights from the current session. The LLM processes the natural language query based on the retrieved contextual information to generate an analytical query. The analytical query is executed against a data source to generate an analytical insight. The session memory module is updated with the natural language query and the analytical insight, and the analytical insight is provided to the user.

In one or more embodiments, the system is configured to process natural language queries from different users, such as but not limited to, business analysts, executives, or other professionals who rely on data-driven insights for decision-making.

In one or more embodiments, the system is configured to receive the query from the user through a chat-based user interface, enabling seamless, conversational interaction. The chat-based user interface is configured to receive the query in various types and modes, including but not limited to text, voice, or a combination thereof. For instance, the system is also configured to accept typed text inputs for quick queries, voice commands for hands-free interactions, or multi-modal inputs where users may switch between text and voice within the same session.

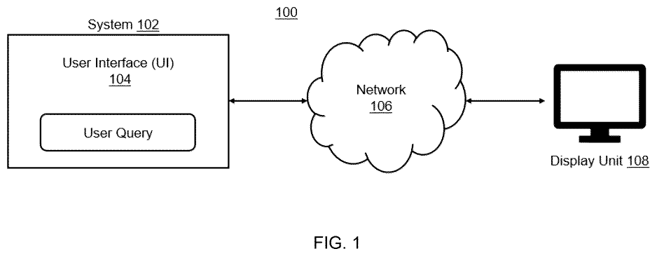

FIG. 1 is a diagram that illustrates an exemplary environment 100 within which various embodiments of the present disclosure may function. Referring to FIG. 1, the environment 100 comprises a system 102 with a user interface (UI) 104, a network 106, and a display unit 108.

As shown in FIG. 1, the system 102 is configured to process a natural language query submitted by the user, enabling an interactive experience that simulates a conversation with a skilled analyst. This conversational approach allows the user to engage in an intuitive dialogue, wherein they can input questions naturally and receive relevant insights in a desired format.

The UI 104 of the system 102 refers to an interactive platform where the user can enter initial questions (natural language queries). The UI 104 is also designed to receive inputs of various types, allowing for flexible and adaptable user interactions.

In one or more embodiments, the UI 104 refers to a visual interface that enables the user to interact with electronic devices through graphical elements, such as icons, buttons, and windows. The intuitive design simplifies the user experience by allowing individuals to navigate and execute tasks more easily.

In some non-limiting embodiments, the UI 104 is designed to receive a diverse range of input types and forms, accommodating various user preferences and operational needs such as keyboard and mouse interactions, as well as modalities like touch, voice recognition, and natural language processing.

The network 106 includes communication networks operable to facilitate communication, either wirelessly or wired. The network 106 connects a plurality of computer systems. The network 106 may comprise, for example, an intranet, local area network, wide area network, the internet, public switched telephone network (PSTN), network of networks, or other network.

In one or more embodiments, the network 106 facilitates connection between the system 102 and the display unit 108 via one or more communication channels.

In one or more embodiments, the display unit 108 is configured to present the generated insights to the user in a visually intuitive and interactive manner. The display unit 108 can include, but is not limited to, devices such as, interactive dashboards, touchscreen displays, projection systems, and wearable displays.

In some non-limiting embodiments, the display unit 108 can be located within an enterprise environment or at any other remote location, providing flexibility in accessing and presenting insights to users. For instance, in an enterprise setting, the display unit 108 could be integrated into centralized workstations or conference room systems, facilitating collaborative decision-making among teams. Conversely, in remote locations, the display unit could be accessed via portable devices such as laptops, tablets, or smartphones, ensuring seamless connectivity and uninterrupted workflow regardless of the user's physical location.

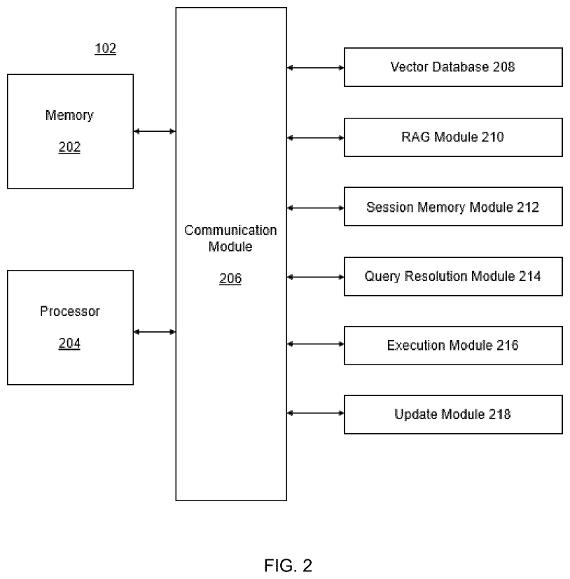

FIG. 2 is a diagram that illustrates the system 102 for processing natural language queries, in accordance with an embodiment of the present disclosure. Referring to FIG. 2, the system 102 comprises a memory 202, a processor 204, a communication module 206, a vector database 208, a RAG module 210, a session memory module 212, a query resolution module 214, an execution module 216, and an update module 218, operatively coupled through communication pathways.

The memory 202 may comprise suitable logic, and/or interfaces, that may be configured to store instructions (for example, computer-readable program code) that can implement various aspects of the present disclosure.

The processor 204 may comprise suitable logic, interfaces, and/or code that may be configured to execute the instructions stored in the memory 202 to implement various functionalities of the system 102 in accordance with various aspects of the present disclosure. The processor 204 may be further configured to communicate with various modules of the system 102 via the communication module 206.

The vector database 208 may be configured to store semantic model data including high-dimensional representations of both structured and unstructured data relevant to the system's 102 operations. The vector database 208 may include specialized logic, interfaces, and algorithms configured to support data storage and retrieval operations.

In some non-limiting embodiments, the vector database 208 that is used can be a PG Vector extension of PostgreSQL database. PG Vector allows PostgreSQL databases to store and query vector embeddings efficiently, enabling similarity search, nearest neighbor search, etc., directly within the database.

In some non-limiting embodiments, the system 102 is also configured to utilize one or more other vector databases such as, but not limited to, Pinecone, and FAISS.

The system 102, upon receiving a natural language query from the user via the UI 104 in a current session, accesses the vector database 208 to retrieve contextual information relevant to the query. The contextual information, stored as high-dimensional embeddings within the vector database 208, improves the system's 102 ability to interpret the user's intent by identifying semantically related data points.

In one or more embodiments, the current session may include an active period of interaction between the user and the system 102, beginning when the user initiates a query through the UI 104 and continuing as long as the user engages in that specific conversational thread.

A retrieval-augmented-generation (RAG) module 210 may comprise suitable logic, code, and/or interface that is configured to implement a RAG model on the natural language query. The RAG module 210 is configured to retrieve contextual information associated with the natural language query by identifying relevant metadata entities, and accessing the session memory module 212 to obtain previous queries and corresponding insights.

In some non-limiting embodiments, the RAG model that is implemented is a pre-trained transformer model from the sentence transformers library, designed to produce embeddings that work well for tasks such as, but not limited to semantic search or clustering. It converts textual data into fixed-size vectors representing the meaning of the text.

In one or more embodiments, the RAG module 210 is configured to perform tasks to ensure accurate retrieval and generation of insights from the natural language query. The RAG module 210 tokenizes the natural language query into constituent tokens for downstream processing. The tokenization may segment the query into units comprising words, sub-words, or symbols based on processing requirements. For example, a query like “What is the revenue for Q1?” may be broken down into tokens such as [“What,” “is,” “the,” “revenue,” “for,” “Q1,” “?”]. This tokenization not only simplifies the query structure but also enables the system 102 to focus on each element independently, facilitating precise linguistic and semantic analysis.

In some non-limiting embodiments, tokenization by the RAG module 210 extends beyond unigrams to include the generation of n-grams for the input question. These n-grams encompass unigrams, bigrams, trigrams, and higher-order combinations, determined dynamically based on the length of the question.

In one or more embodiments, the RAG module 210 may be configured to generate vector embeddings for both the query and the relevant data in the system's 102 knowledge base. The embeddings represent the semantic meaning of the query and the stored data as high-dimensional vectors. For instance, the vector embeddings may be generated using one or more deep learning models configured to map textual data into multi-dimensional space.

In one or more embodiments, the RAG module 210 may be configured to perform a similarity analysis by evaluating the vector embeddings of the query tokens against the semantic model data stored within the vector database 208. The process involves assessing the degree of alignment between the vector representations of the natural language query and the pre-encoded semantic data, which includes structured and unstructured information relevant to the system's 102 operations. The comparison enables the module to compute precise similarity scores that reflect the contextual and semantic proximity of the query tokens to stored concepts and entities.

In one or more embodiments, by utilizing the results of the similarity analysis, the RAG module 210 may be configured to identify metadata entities that closely match the query's context. Only entities exceeding a predefined similarity threshold are selected, ensuring the relevance and accuracy of the retrieved data while minimizing extraneous information.

In one or more embodiments, the process of comparing the generated vector embeddings and selecting relevant metadata entities involve several detailed steps, which are developed to efficiently retrieve and rank the most pertinent information based on the user's natural language query.

In one or more embodiments, the RAG module 210 may be configured to compare the generated vector embeddings with the stored semantic model data to calculate similarity scores. The RAG module 210 may be configured to measure the cosine similarity or another distance metric between the query embedding and the embeddings of the stored semantic data. The resulting similarity scores may indicate semantic alignment between stored data and query intent, enabling determination of relevant information.

In one or more embodiments, once similarity scores are computed, the RAG module 210 may be configured to identify specific attributes within the semantic model data that align with the query. The attributes may comprise individual data points, keywords, or features semantically related to query terms. In an exemplary implementation, for a query about ‘sales performance in Q4,’ the system 102 may identify data attributes related to sales figures, quarter identifiers, and time frames.

In one or more embodiments, after identifying the relevant attributes, the RAG module 210 may be configured to rank the identified attributes based on similarity scores. The ranking is based on how closely each attribute matches the user's query. Higher-ranked attributes are those that share a greater semantic similarity to the query, indicating that they are more likely to provide relevant and accurate information. Ranking ensures that the RAG module 210 prioritizes the most pertinent data when generating a response, leading to more meaningful insights for the user.

In one or more embodiments, to further refine the selection process and optimize the retrieval of data, the RAG module 210 may be configured to apply a similarity threshold. Only those attributes whose similarity scores exceed this threshold are selected as relevant metadata entities. The step serves to filter out any data that is not sufficiently aligned with the query, reducing the volume of contextual information that needs to be processed. By limiting the scope to the highest-ranked attributes, the RAG module 210 may be configured to ensure that the selected metadata entities are highly relevant and minimizes the potential for irrelevant or overly general information.

The session memory module 212 may comprise suitable logic, code, and/or interface that is configured to store data related to previous queries and corresponding insights from the current session. In one or more embodiments, the system 102 may be configured to access session memory module 212 to obtain related previous queries and corresponding insights from the current session.

In one or more embodiments, the system 102 may be configured to retrieve previous queries made by the user during the current session. The queries are stored in the session memory module 212 and are crucial for maintaining continuity in the conversation. By referencing earlier queries, the system 102 can understand the progression of the user's line of inquiry, ensuring that each new query is processed in the context of the overall session.

In one or more embodiments, while retrieving the previous queries, the system 102 may be configured to also fetch the insights or responses that were generated in response to those queries. The insights represent the information that was provided to the user earlier in the session and can include data, analysis, or other types of responses. By considering both the previous queries and their corresponding insights, the system 102 gains a fuller understanding of the user's informational needs and how those needs have evolved over the course of the session.

In one or more embodiments, once the relevant previous queries and insights are retrieved, the system 102 may be configured to analyze them to identify potential reference relationships with the natural language query. The step involves detecting whether the natural language query is referencing or building upon the earlier questions or insights. For example, if the user previously asked about sales figures for Q1 and then inquiries about Q2, the system 102 identifies the reference relationship between the two queries.

In one or more embodiments, the system 102 may be configured to identify reference relationships through linguistic analysis of natural language queries. This includes the detection of both implicit and explicit references, extending beyond pronouns (such as ‘it,’ ‘they,’ ‘this’) to encompass broader contextual references (such as ‘the previous data,’ ‘the above question’). Additionally, even when queries lack explicit references, the system 102 automatically carries forward relevant context from previous queries and their insights to resolve subsequent queries. For example, if a user first queries “Sales in 2021” and follows with “across market,” the system 102 intelligently combines the contexts to interpret the second query as “sales across markets in 2021.” This context management ensures accurate interpretation of user intent, whether through explicit referential elements or implicit contextual continuation.

In one or more embodiments, once the pronouns and references are identified, the system 102 may be configured to perform entity matching between identified referential elements and entities from previous queries and insights stored in the session memory module 212. The matching process may comprise searching for various entity types, including but not limited to, data points, metrics, concepts, and temporal references. In one implementation, temporal references such as ‘this year's performance’ may be matched with chronologically relevant performance metrics from session history.

In one or more embodiments, in addition to identifying references, the system 102 may be configured to analyze temporal relationships within query sequences. The temporal analysis may comprise evaluation of chronological query ordering and identification of temporal references (such as ‘last month's sales’ or ‘performance change after Q1’). The analysis may enable temporal context preservation across query sequences.

In one or more embodiments, the session memory module 212 is updated with the natural language query and the analytical insight by storing the natural language query with a temporal identifier. The temporal identifiers may comprise chronological markers and sequence indicators within current sessions. The storage mechanism may facilitate contextual query retrieval and reference resolution in subsequent interactions.

In one or more embodiments, the system 102 may be configured to establish direct linkages between stored natural language queries and derived analytical insights. The linkage mechanism may enable traceability between queries and corresponding insights, facilitating insight retrieval during subsequent query processing.

In one or more embodiments, the system 102 may be configured to establish and maintain reference chains connecting contextually related queries within sessions. The reference chains may comprise identified logical dependencies, including but not limited to, follow-up queries, clarification requests, and contextual references. The reference chain mechanism may enable contextual interpretation of subsequent queries based on established conversation threads.

In one or more embodiments, the session memory module 212 may be configured to maintain chronological query sequences within current sessions. The chronological organization may comprise temporal markers and sequential indicators for preserving query order and temporal relationships.

In one or more embodiments, the session memory module 212 may be configured to maintain entity mappings across sequential queries. The mapping mechanism may track entity references between successive queries and maintain reference resolution data. In one implementation, for queries containing pronouns (such as ‘it’) referring to previously mentioned entities (such as ‘revenue’), the system 102 may utilize entity mappings to resolve referential continuity.

In one or more embodiments, the session memory module 212 may be configured to maintain relationships between queries and their corresponding analytical insights. The relationship maintenance mechanism may enable comprehensive tracking of query-insight associations, preserving analytical context across the session.

In one or more embodiments, the session memory module 212 may be configured to store contextual information utilized during insight generation, including relevant metadata, applied filters, and processing parameters. The contextual storage mechanism may preserve insight generation context, enabling reproducibility and reference during subsequent query processing within the session.

In one or more embodiments, the session memory module 212 may be configured to include a query storage component. The query storage component may be configured to: maintain chronological query sequences, assign temporal identifiers to incoming queries, and establish entity mappings between successive queries in the sequence. The storage mechanism may enable temporal and referential continuity across query processing.

In one or more embodiments, the session memory module 212 may be configured to include a reference resolution component. The reference resolution component may be configured to identify reference relationships through analysis of pronouns, contextual references, and temporal relationships between queries. The resolution mechanism may enable accurate interpretation of contextually dependent queries.

In one or more embodiments, the session memory module 212 may be configured to include an insight management component. The insight management component may be configured to store analytical insights, maintain query-insight relationships, and preserve contextual information utilized during insight generation. The management mechanism may enable comprehensive tracking of analytical context.

The query resolution module 214 may comprise suitable logic, code, and/or interface that is configured to process the natural language query based on the contextual information to generate an analytical query.

In one or more embodiments, the query resolution module 214 may be configured to process the natural language query through generation of chain-of-thought prompts incorporating contextual information and processing instructions. The processing mechanism may extract session details including, but not limited to, prior queries, associated insights, identified entity references, and temporal relationships from the current session.

In some non-limiting embodiments, the chain-of-thought prompt may be configured to function as an interpretative layer guiding underlying models or algorithms. The prompt structure may incorporate processing instructions including, but not limited to, entity resolution rules, query reformulation guidelines, and contextual emphasis parameters. The interpretative mechanism may enable precise query processing within an established context.

In one or more embodiments, the query resolution module 214 may be configured to apply the LLM for processing natural language queries. The processing may comprise one or more operations including entity reference resolution from the current session, linguistic error correction, and query format adaptation for analytical processing.

The query resolution module 214 may utilize LLMs that can be configured based on implementation requirements. These language models support fine-tuning through Parameter Efficient Fine-Tuning (PEFT) techniques, enabling adaptation to specific analytical contexts while maintaining computational efficiency. The fine-tuning approaches may include techniques for adapting the model's parameters while preserving its core capabilities.

In one or more embodiments, the LLM may be configured to resolve entity references from the current session through identification and mapping of ambiguous terms. The resolution mechanism may map pronouns and references to specific entities or insights derived from previous queries in the current session. The mapping process may enable contextual continuity across query sequences.

In one or more embodiments, the query resolution module 214 may be configured to identify and process referential elements within the natural language query. The identification mechanism may detect ambiguous terms including, but not limited to, pronouns (such as ‘it,’ ‘they’) and indirect references (such as ‘the previous report,’ ‘those metrics’). The detection mechanism may isolate terms requiring clarification for preserving query intent.

In one or more embodiments, for resolving entity references from the current session, the query resolution module 214 may be configured to establish mappings between identified referential elements and entities from previous queries. The mapping mechanism may utilize the session memory module 212 for locating corresponding entities and data points from prior queries or generated insights. The process may incorporate contextual relationships and temporal markers for establishing accurate reference-entity associations.

In one or more embodiments, for resolving entity references from the current session, the query resolution module 214 may be configured to perform entity substitution while maintaining semantic coherence. The substitution mechanism may replace ambiguous terms with resolved entities based on established mappings. The semantic preservation mechanism may enable subsequent analytical processing while maintaining query intent.

In one or more embodiments, for correcting linguistic errors, the LLM may be configured to perform linguistic error correction within natural language queries. The correction mechanism may detect and rectify various error types including, but not limited to, misspellings, grammatical inaccuracies, and syntactical inconsistencies. The LLM may further be configured to evaluate term relevance within domain context, enabling query refinement through irrelevant token removal or issue flagging for user intervention in cases of insufficient meaningful content.

In one or more embodiments, the query resolution module 214 may be configured to correct linguistic errors through misspelling identification and correction. The identification mechanism may analyze query tokens through comparison with lexicons, domain-specific vocabularies, and dynamic dictionaries. The query resolution module 214 may utilize probabilistic language models for detecting tokens deviating from expected patterns. The analysis mechanism may evaluate contextual elements including, but not limited to, surrounding tokens, grammatical structures, and domain-specific constraints for determining user intent.

The query resolution module 214 may be configured to generate and apply spelling corrections. The correction mechanism may replace erroneous tokens with lexicon-matched terms or generate ranked correction candidates based on semantic similarity and context. In one implementation, domain-specific terms such as ‘finanical’ may be corrected to ‘financial’based on business context analysis.

In one or more embodiments, correcting linguistic errors include evaluating relevance of tokens to the domain context. The query resolution module 214 may be configured to examine each token within the query to determine its semantic relationship to the domain context. This is achieved using pre-trained domain-specific models, ontologies, or embeddings that map tokens to their contextual meanings within the relevant knowledge space. For instance, in a financial domain, the token “balance” may be interpreted as “account balance,” whereas in a different domain, it might refer to “physical stability.”

In one or more embodiments, the query resolution module 214 may be configured to cross-reference the tokens with a domain-specific lexicon or a vector-based semantic model stored in the vector database 208. Tokens that match known domain-specific terms are marked as relevant, while those lacking significant alignment are flagged for further analysis. Tokens that fail to align with the domain context, such as overly generic terms, unrelated words, or noise (e.g., “umm,” “uh”), are identified as irrelevant. For example, in a query about supply chain optimization, a token like “social” may be deemed irrelevant unless used in the context of “social responsibility.” Once the relevance of each token is evaluated, the query resolution module 214 may be configured to reconstruct the query by either removing irrelevant tokens or rephrasing the query to better fit the domain context. For instance, a query such as “What's the weather like for the quarterly reports?” may be refined to “What are the trends in quarterly reports?”

In one or more embodiments, correcting linguistic errors include reconstructing the natural language query by either removing tokens determined to be irrelevant while preserving grammatical structure or generating a notification when no relevant tokens are identified. The query resolution module 214 may be configured to analyze the natural language query to isolate tokens that lack relevance to the query's context or domain. For instance, when generating insights or answering user questions from underlying data, the system 102 accounts for the domain specificity of the solution. If the solution is built using data from a particular domain, such as insurance, and the user poses a query related to a different domain, such as media, the system 102 identifies and flags the question or tokens as irrelevant, even if the query itself is meaningful. Domain-specific models and semantic analysis techniques are used to flag tokens that do not contribute to the query's meaning. Once irrelevant tokens are identified, the query resolution module 214 may be configured to restructure the query by eliminating these tokens while preserving the grammatical integrity of the remaining text. For example, a query such as “Show me the best options, um, for investments?” may be reconstructed to “Show me the best options for investments.” Similarly, a query like “Hey, uh, what's the total revenue, you know, for last quarter?” would be refined to “What's the total revenue for last quarter?” The reconstruction process ensures that the refined query maintains proper syntax and semantics, facilitating seamless processing by downstream components, such as the query resolution module 214 or analytical engine.

In one or more embodiments, for adapting the natural language query format for analytical processing, the LLM may be configured to reformulate the analytical query to align with the requirements of downstream analytical modules. This includes converting the analytical query into a structured format, optimizing its phrasing for compatibility with semantic or analytical models, and incorporating processing instructions that guide the system 102 in generating precise and actionable insights.

The system 102 may be configured to apply an LLM for processing natural language queries following chain-of-thought prompt generation. The LLM processing may comprise multiple tasks including, but not limited to, entity reference resolution from the current session, linguistic error correction, and query format adaptation for analytical processing.

In one or more embodiments, the LLM may be configured to resolve entity references within natural language queries through analysis of prior queries and insights from the current session. The resolution mechanism may enable mapping of referential terms including, but not limited to, ‘this,’ ‘those,’ and specific data references (such as ‘Q1 sales’) to corresponding entities based on conversational context.

In one or more embodiments, the LLM may be configured to identify and correct linguistic errors within user queries. The correction mechanism may address various error types including, but not limited to, spelling mistakes, grammatical issues, and ambiguities. The error correction mechanism may enhance user intent interpretation, thereby improving response accuracy.

In one or more embodiments, the LLM may be configured to adapt the user's natural language query into a format that is suitable for analytical processing. This may involve rephrasing or restructuring the query to align with the system's 102 underlying analytical models, data structures, or query interfaces. For example, the system 102 may convert an ambiguous query into a structured format suitable for analytics engine processing.

In one or more embodiments, the system 102 may be configured to implement comprehensive reference resolution through two primary mechanisms. First, it analyzes natural language queries for explicit references, including pronouns (such as “it,” “they,” “this,” “those”) and direct reference terms that link to entities from previous queries or insights. Second, it employs contextual analysis to resolve implicit references where no explicit reference terms are present. This dual approach enables the system 102 to maintain contextual continuity by: (1) mapping explicit references to their corresponding entities, and (2) inferring implicit relationships based on conversational context and query structure. The resolution mechanism ensures accurate query interpretation regardless of whether references are made explicitly through pronouns or implicitly through contextual continuation.

In one or more embodiments, once the pronouns and references are identified, the system 102 may be configured to search the session memory module 212 to find the corresponding entities mentioned in previous queries or responses. For example, if a previous query referred to “sales performance for Q1” and the current query contains “what about this year's sales?” the system 102 may be configured to match the reference to “this year's sales” with the corresponding “Q1 sales” entity from earlier in the current session.

In one or more embodiments, after matching the pronouns and references with the correct entities, the system 102 may be configured to perform entity substitution. The substitution mechanism may replace resolved pronouns and references with corresponding entities. The system 102 may be further configured to implement linguistic error correction through query scanning for misspelled terms and typographical errors. The correction mechanism may utilize spelling correction algorithms for suggesting and implementing term replacements.

In one or more embodiments, the system 102 may be configured to evaluate each token (i.e., word or term) in the query to determine its relevance to the domain context. This involves assessing whether the tokens align with the specific concepts or entities within the domain of the query, such as, but not limited to, business metrics, performance indicators, or other domain-specific terminology. Tokens that are deemed relevant are retained, while irrelevant tokens, which do not contribute meaningfully to the query, are flagged for additional processing.

In one or more embodiments, after evaluating token relevance, the system 102 may be configured to reconstruct the natural language query by removing irrelevant tokens, and generating a notification when no relevant tokens are identified.

In one or more embodiments, the system 102 may be configured to remove irrelevant tokens while preserving grammatical structures. The removal of irrelevant tokens may ensure query coherence post-modification.

In one or more embodiments, the system 102 may be configured to generate user notifications based on token relevance analysis. The notification may be triggered when queries contain insufficient domain-relevant tokens or exhibit excessive vagueness. The feedback mechanism may enable user awareness of query refinement requirements.

In one or more embodiments, the system 102 may be configured to implement processing instructions for temporal reference resolution. The resolution mechanism may interpret time-based terms including, but not limited to, ‘last month,’ ‘next quarter,’ and establish relationships with specific data points. The temporal processing mechanism may enable contextual understanding of time-based references within session contexts.

In one or more embodiments, the instructions include predefined templates that guide the rephrasing or restructuring of the natural language query into a more formalized or structured format suitable for analytical processing, and the rephrased query remains in natural language. The system 102 is capable of handling a wide range of question types, such as “What,” “Which,” “Why,” “When,” trend analysis, share analysis, growth rate, forecast, key driver analysis, Top N queries, and more, covering areas like summarization, forecasting, predictive, and diagnostic analysis.

In one or more embodiments, the system 102 utilizes sample question templates to understand and process user queries effectively. These templates help the LLM understand the types of queries the underlying system can handle.

For example, when a user asks, ‘Show me sales growth,’ the system 102 understands this intent by referencing similar patterns in the predefined templates. The template-based learning approach ensures the system 102 can flexibly handle diverse analytical requests.

In some embodiments, the execution module 216 may comprise suitable logic, code, and/or interface that is configured to process the analytical query directly in natural language format. In other embodiments, the execution module 216 converts the query into a structured format for execution against a data source to generate an analytical insight. Therefore, the execution module 216 may be configured to process queries through two implementation paths: direct natural language processing or structured query conversion. The implementation path is determined based on the specific requirements of the target data sources and the deployment configuration. The execution mechanism may perform operations against multiple data sources including, but not limited to, relational databases, data warehouses, and vector databases.

In some non-limiting embodiments, when structured query conversion is required, the system 102 may convert the query template into an SQL query within the execution module 216, enabling execution against various data sources, such as relational databases, data warehouses, and vector databases, to perform the required analysis.

The update module 218 may comprise suitable logic, code, and/or interface that is configured to update the session memory module 212 with the natural language query and the analytical insight. Specifically, when a natural language query is processed and an analytical insight is generated, the update module 218 may be configured to store this information in the session memory module 212.

In one or more embodiments, the update module 218 may be configured to establish associations between natural language queries and corresponding analytical insights. The association mechanism may incorporate additional metadata including, but not limited to, temporal identifiers and contextual references. The storage mechanism may maintain comprehensive query-insight relationships with associated contextual information.

In one or more embodiments, the update module 218 may be configured to ensure that the session memory module 212 retains a chronological sequence of queries, preserves entity mappings across successive queries, and maintains reference relationships between the natural language queries and their respective insights.

In one or more embodiments, the system 102 may be configured to communicate the analytical insight to the user through the display unit 108, which is designed to present information in an intuitive and user-friendly manner. Once the analytical query is executed and the resulting insight is generated, the system 102 may be configured to format the insight appropriately for display.

In one or more embodiments, the system 102 may be configured to implement multiple insight presentation formats based on analysis types. The presentation mechanism may generate various output formats including, but not limited to, textual descriptions, data visualizations (such as charts, graphs, or tables), and interactive data exploration widgets. The format selection mechanism may optimize insight accessibility and user comprehension.

In a non-limiting embodiment, the models and databases utilized within the system 102 are interchangeable with any general-purpose models and databases, thereby providing adaptability and flexibility to accommodate various implementation requirements and technological preferences.

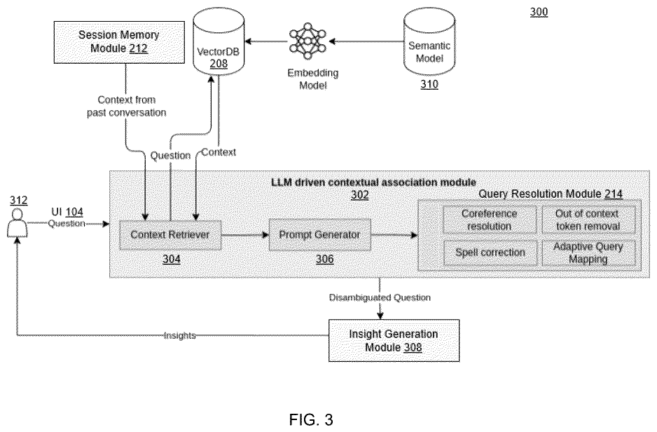

FIG. 3 is an exemplary diagram 300 that illustrates the framework of the system 102 for processing natural language queries in a business analytics context, in accordance with an embodiment of the disclosure.

Referring to FIG. 3, in one implementation focusing on financial analytics, the system 102 processes a sequence of natural language queries from an analyst 312 evaluating quarterly performance. The analyst 312 initiates with “What was our revenue in Q1 2024?” through the UI 104, which acts as the primary input mechanism. This query enters the LLM-driven contextual association module 302, which orchestrates the retrieval and resolution of relevant contextual information to ensure a coherent response.

The process begins when the context retriever 304, a sub-module of the LLM-driven contextual association module 302, accesses the session memory module 212 to extract contextual information. For the initial query, it retrieves revenue-related context including revenue definitions, calculation methods, and standard business rules. Simultaneously, the context retriever 304 interacts with the vector database 208 to fetch high-dimensional semantic embeddings of financial data including revenue figures, temporal markers, and associated metadata. These embeddings are pre-generated by an embedding model trained by a semantic model 310, to convert diverse financial data types into vectorized representation.

When the analyst 312 follows up with “In Europe”, the system 102 processes through the prompt generator 306 to construct a chain-of-thought prompt. The prompt combines the natural language query fragment, previous query context about revenue, and instructions for resolving relationships between queries. This enables the LLM to generate a complete query: “What is the total revenue in Q1 2024 in Europe?”

As the analyst 312 continues with “across years”, the prompt generator 306 creates a prompt that preserves the geographical context while incorporating instructions for temporal expansion. The LLM resolves this to “What is the total revenue in Europe across years?”. When the analyst 312 shifts focus with “what about Profit”, the system 102 maintains the contextual elements while switching the metric of interest.

When the analyst 312 follows up with “across mkt”, the system 102 processes this through the prompt generator 306, which includes instructions for abbreviation resolution using the query resolution module 214, resulting in a query about markets. Subsequently, when the analyst 312 states “Remove market”, the system 102 preserves the essential context while removing the specified dimension. The analyst 312 then follows with “for electronic appliances”, where the prompt includes instructions for spell correction, enabling the LLM to process a properly formatted query about electronic appliances.

Finally, when the analyst 312 asks about “Claim rate in India”, the system's 102 domain relevance check identifies this as outside the financial analytics scope and generates appropriate feedback. Throughout this interaction sequence, each resolved query is processed by the insight generation module 308, which interfaces with the vector database 208 to generate relevant analytical insights displayed through the display unit 108.

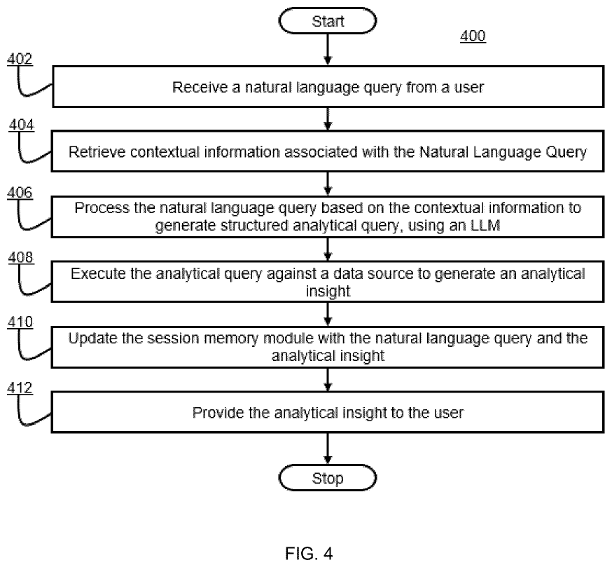

FIG. 4 is a diagram that illustrates a flow chart for a method for processing natural language queries, in accordance with an embodiment of the disclosure.

At 402, a natural language query is received from the user via the UI 104. The UI 104 refers to a visual interface that enables the user to interact with electronic devices through graphical elements, such as icons, buttons, and windows.

At 404, contextual information associated with the natural language query is retrieved. The system 102, upon receiving a natural language query from the user via the UI 104 in a current session, it accesses the vector database 208 to retrieve contextual information relevant to the query. The contextual information, stored as high-dimensional embeddings within the vector database 208, improves the system's 102 ability to interpret the user's intent by identifying semantically related data points.

In one or more embodiments, the current session refers to an active period of interaction between the user and the system 102, beginning when the user initiates a query through the UI 104 and continuing as long as the user engages in that specific conversational thread.

A retrieval-augmented-generation (RAG) module 210 may comprise suitable logic, code, and/or interface that is configured to implement a RAG model on the natural language query. The RAG module 210 is configured to retrieve contextual information associated with the natural language query by identifying relevant metadata entities, and accessing the session memory module 212 to obtain related previous queries and corresponding insights from the current session.

In some non-limiting embodiments, the RAG model that is implemented is a pre-trained transformer model from the sentence transformers library, designed to produce embeddings that work well for tasks like semantic search or clustering. It converts textual data into fixed-size vectors representing the meaning of the text.

In one or more embodiments, the RAG module 210 is configured to perform tasks to ensure accurate retrieval and generation of insights from the natural language query. The RAG module 210 tokenizes the natural language query into constituent tokens by breaking down the user's query into smaller, meaningful units (tokens), such as words, sub-words, and symbols depending on the granularity required for downstream processing. For example, a query like “What is the revenue for Q1?” may be broken down into tokens such as [“What,” “is,” “the,” “revenue,” “for,” “Q1,” “?”]. This tokenization not only simplifies the query structure but also enables the system 102 to focus on each element independently, facilitating precise linguistic and semantic analysis.

In some non-limiting embodiments, tokenization by the RAG module 210 extends beyond unigrams to include the generation of n-grams for the input question. These n-grams encompass unigrams, bigrams, trigrams, and higher-order combinations, determined dynamically based on the length of the question.

In one or more embodiments, the RAG module 210 generates vector embeddings for both the query and the relevant data in the system's 102 knowledge base. The embeddings represent the semantic meaning of the query and the stored data as high-dimensional vectors. For instance, the vector embeddings are created using advanced techniques such as deep learning models, which map the textual data into a multi-dimensional space where similar meanings are closer together.

In one or more embodiments, the RAG module 210 performs a similarity analysis by evaluating the vector embeddings of the query tokens against the semantic model data stored within the vector database 208. The process involves assessing the degree of alignment between the vector representations of the natural language query and the pre-encoded semantic data, which includes structured and unstructured information relevant to the system's 102 operations. The comparison enables the module to compute precise similarity scores that reflect the contextual and semantic proximity of the query tokens to stored concepts and entities.

In one or more embodiments, by utilizing the results of the similarity analysis, the RAG module 210 identifies metadata entities that closely match the query's context. Only entities exceeding a predefined similarity threshold are selected, ensuring the relevance and accuracy of the retrieved data while minimizing extraneous information.

In one or more embodiments, the process of comparing the generated vector embeddings and selecting relevant metadata entities involve several detailed steps, which are developed to efficiently retrieve and rank the most pertinent information based on the user's natural language query.

In one or more embodiments, the RAG module 210 compares the generated vector embeddings with the stored semantic model data to calculate similarity scores. The RAG module 210 measures the cosine similarity or another distance metric between the query embedding and the embeddings of the stored semantic data. The resulting similarity scores indicate how closely the stored data matches the semantic intent of the user's query, allowing the system 102 to determine which pieces of information are most relevant.

In one or more embodiments, the system 102 retrieves previous queries made by the user during the current session. The queries are stored in the session memory module 212 and are crucial for maintaining continuity in the conversation. By referencing earlier queries, the system 102 can understand the progression of the user's line of inquiry, ensuring that each new query is processed in the context of the overall session.

In one or more embodiments, while retrieving the previous queries, the system 102 also fetches the insights or responses that were generated in response to those queries. The insights represent the information that was provided to the user earlier in the session and can include data, analysis, or other types of responses. By considering both the previous queries and their corresponding insights, the system 102 gains a fuller understanding of the user's informational needs and how those needs have evolved over the course of the session.

In one or more embodiments, once the relevant previous queries and insights are retrieved, the system 102 analyzes them to identify potential reference relationships with the current natural language query. The step involves detecting whether the current query is referencing or building upon the earlier questions or insights. For example, if the user previously asked about sales figures for Q1 and then inquiries about Q2, the system 102 identifies the reference relationship between the two queries.

In one or more embodiments, the system 102 may be configured to identify reference relationships through linguistic analysis of natural language queries. This includes the detection of both implicit and explicit references, extending beyond pronouns (such as ‘it,’ ‘they,’ ‘this’) to encompass broader contextual references (such as ‘the previous data,’ ‘the above question’). The referential elements enable the system 102 to accurately interpret contextual dependencies between current queries and prior session elements, ensuring robust handling of diverse referencing patterns.

In one or more embodiments, once the pronouns and references are identified, the system 102 proceeds to match them with specific entities mentioned in previous queries and their corresponding insights. This involves searching through the session memory module 212 for entities, such as data points, metrics, or concepts, that were previously discussed. For example, if the query contains “this year's performance,” the system 102 would search for references to performance-related data from earlier in the session and match “this year's” to the relevant temporal entity.

In one or more embodiments, in addition to identifying references, the system 102 also analyzes the temporal relationships between the current query and prior queries, which includes understanding the chronological order of the queries within the session and determining if the current query refers to something that occurred earlier (e.g., “last month's sales”) or is asking for an update on an earlier question (e.g., “how did the performance change after Q1?”).

In one or more embodiments, the session memory module 212 is updated with the natural language query and the analytical insight by storing the natural language query with a temporal identifier. The system 102 assigns a unique temporal identifier to the natural language query, capturing the time and sequence of the query within the current session to preserve the query's chronological context, facilitating accurate referencing and retrieval during subsequent interactions.

At 406, the natural language query is processed by an LLM based on the contextual information. In one or more embodiments, the query resolution module 214 processes the natural language query by generating a chain-of-thought prompt containing the contextual information and processing instructions. The process begins by extracting relevant details from the current session, including prior queries, associated insights, and any identified entity references or temporal relationships. Based on the implementation, the processed query may remain in natural language format or be converted to an analytical query.

In some non-limiting embodiments, the chain-of-thought prompt acts as an intermediary layer, guiding the underlying model or algorithm in interpreting the query with precision. It includes explicit processing instructions, such as, for example, entity resolution rules, query reformulation guidelines, contextual emphasis, etc.

In one or more embodiments, the query resolution module 214 processes the natural language query by applying the LLM to perform wither one of, resolving entity references from the current session, correcting linguistic errors, and adapting the natural language query format for analytical processing.

In one or more embodiments, for resolving entity references from the current session, the LLM identifies ambiguous terms, such as pronouns or references, in the natural language query and resolves them by mapping these references to specific entities or insights derived from previous queries in the current session.

In one or more embodiments, for resolving entity references from the current session, the query resolution module 214 identifies pronouns and references in the natural language query. The query resolution module 214 analyzes the natural language query to detect ambiguous terms, such as pronouns (e.g., “it,” “they”) or indirect references (e.g., “the previous report,” “those metrics”). This step allows the system 102 to isolate terms requiring clarification to maintain the query's intended meaning.

In one or more embodiments, for resolving entity references from the current session, the query resolution module 214 matches the identified pronouns and references with entities from previous queries. Once ambiguous terms are identified, the query resolution module 214 consults the session memory module 212 to locate corresponding entities or data points from prior queries or generated insights. The process leverages contextual relationships and temporal markers to establish accurate mappings between the references and their associated entities.

In one or more embodiments, for resolving entity references from the current session, the query resolution module 214 substitutes resolved entities to maintain semantic coherence. After determining the appropriate matches, the system 102 replaces the ambiguous terms in the natural language query with the resolved entities. This substitution preserves the original query's intent while ensuring semantic clarity, enabling subsequent analytical processing without misinterpretation.

In one or more embodiments, for correcting linguistic errors, the LLM detects and rectifies errors in the natural language query, such as misspellings, grammatical inaccuracies, or syntactical inconsistencies. Additionally, the LLM evaluates the relevance of terms in the query to the domain context, either refining the query by removing irrelevant tokens or flagging issues for user intervention if the query lacks sufficient meaningful content.

In one or more embodiments, correcting linguistic errors include identifying and correcting misspelled terms in the natural language query. The query resolution module 214 analyzes the natural language query to identify potential misspellings by comparing the query's tokens with a predefined lexicon, domain-specific vocabulary, or a dynamically updated dictionary. The query resolution module 214 may also utilize probabilistic language models to flag tokens that deviate from expected linguistic patterns. The query resolution module 214 evaluates the context in which the misspelled term appears. For instance, the query resolution module 214 considers surrounding tokens, grammatical structure, and domain-specific constraints to determine the likely intent of the user.

At 408, the analytical query is executed against a data source to generate an analytical insight. In one or more embodiments, the execution module 216 processes the query through either natural language processing or analytical conversion based on the implementation. The execution module 216 performs operations against one or more data sources, such as relational databases, data warehouses, or vector databases.

In some non-limiting embodiments, the system 102 may convert the query template into an SQL query within the execution module 216, which allows the system 102 to execute the query against various data sources, such as relational databases, data warehouses, and vector databases, to perform the required analysis. In other embodiments, the system 102 may execute the natural language query directly against compatible data sources.

At 410, the session memory module 212 is updated with the natural language query and the analytical insight. The update module 218 updates the session memory module 212 with the natural language query and the analytical insight. Specifically, when a natural language query is processed and an analytical insight is generated, the update module 218 stores this information in the session memory module 212.

In one or more embodiments, storing the information includes associating the natural language query with its corresponding analytical insight, along with additional metadata, such as temporal identifiers and contextual references.

Finally, at 412 the analytical insight is provided to the user. the system 102 communicates the analytical insight to the user through the display unit 108, which is designed to present information in an intuitive and user-friendly manner. Once the analytical query is executed and the resulting insight is generated, the system 102 formats this insight appropriately for display.

The method and system is advantageous in that it significantly enhances the accuracy and efficiency of retrieving analytical insights from structured data sources through its reference resolution mechanism. By resolving ambiguities in natural language queries through precise mapping of referential elements, the system ensures accurate identification and matching of intended entities with corresponding data points, thereby enabling users to obtain precise insights without requiring expertise in structured query formats.

Further, the method and system is advantageous in that it maintains contextual continuity across sequential queries within current sessions through its session memory module. The technical implementation ensures each new query is processed with preserved context from previous interactions, enabling users to conduct complex analytical investigations through natural conversational flows. This architecture eliminates the technical barrier of context reestablishment, allowing users to focus on their analytical objectives.

Yet another advantage of the method and system is the LLM-driven approach for resolving references within current sessions, enabling natural query progression. The reference resolution mechanism enables precise mapping of pronouns and referential elements (such as “it,” “they,” or “this”) to their corresponding entities from previous queries, allowing users to frame follow-up questions as they would in human conversations. This technical advancement removes the constraint of explicitly restating context in each query while maintaining processing accuracy.

Additionally, the method and system is advantageous in that it enables users to interact with complex datasets through intuitive conversational interfaces while maintaining technical precision. The implementation automatically preserves context across query sequences, allowing users to naturally progress from broad queries to specific analyses. This technical capability is particularly valuable in analytical scenarios where insights from one query inform subsequent inquiries.

Furthermore, the method and system is advantageous in that it implements adaptive query mapping, supported by a knowledge store encompassing various question types the underlying system can resolve. These include descriptive, forecast, predictive, and diagnostic questions, as well as key driver analysis. This knowledge store serves as a critical resource for the LLM, enabling it to map user inquiries to appropriate templates while accommodating natural variations in human expression. This capability allows users to phrase their analytical inquiries naturally, with the system ensuring accurate interpretation, structured processing, and precise analytical operations, all while maintaining session context.

What is claimed is:

1. A computer-implemented method for processing natural language queries, comprising:
receiving, by one or more processors, a natural language query from a user during a current session;
retrieving, by the one or more processors, contextual information associated with the natural language query by:
applying a retrieval-augmented-generation (RAG) model to the natural language query to identify relevant metadata entities;
accessing a session memory module to obtain related previous queries and corresponding insights from the current session;
processing, by a large language model (LLM), the natural language query based on the contextual information to generate an analytical query;
executing, by the one or more processors, the analytical query against a data source to generate an analytical insight;
updating, by the one or more processors, the session memory module with the natural language query and the analytical insight; and
providing the analytical insight to the user.

2. The method of claim 1, wherein applying the RAG model comprises:
tokenizing the natural language query into constituent tokens;
generating vector embeddings for the constituent tokens;
comparing the generated vector embeddings against semantic model data stored in a vector database to determine semantic similarities; and
selecting metadata entities based on the determined semantic similarities.

3. The method of claim 2, wherein comparing the generated vector embeddings and selecting metadata entities comprises:
computing similarity scores between the vector embeddings and the stored semantic model data;
identifying specific attributes within the semantic model data that match the natural language query;
ranking the identified attributes based on the computed similarity scores; and
selecting a subset of highest-ranked attributes that exceed a similarity threshold as the relevant metadata entities to minimize contextual information volume.

4. The method of claim 1, wherein processing the natural language query comprises:
identifying potential reference relationships between the natural language query and the previous queries by:
analyzing the natural language query for presence of explicit references including pronouns and reference terms;
analyzing the natural language query for implicit references based on query structure and content;
matching the analyzed explicit and implicit references with entities mentioned in the previous queries; and
determining temporal relationships between the natural language query and the previous queries within the current session.

5. The method of claim 1, wherein updating the session memory module comprises:
storing the natural language query with a temporal identifier;
associating the generated analytical insight with the stored natural language query;
maintaining reference chains between related queries in the current session, wherein maintaining the reference chains comprises:
maintaining a chronological sequence of queries from the current session;
maintaining entity mappings between successive queries within the chronological sequence;
maintaining relationships between the queries and their corresponding insights; and
maintaining contextual information utilized during generation of each corresponding insight.

6. The method of claim 1, wherein processing the natural language query comprises:
generating a chain-of-thought prompt containing the contextual information and processing instructions; and
applying the LLM to perform at least one of resolving entity references from the current session, correcting linguistic errors, and adapting the natural language query format for analytical processing.

7. The method of claim 6, wherein resolving entity references comprises:
identifying pronouns and references in the natural language query;
matching the identified pronouns and references with entities from previous queries; and
substituting resolved entities to maintain semantic coherence.

8. The method of claim 7, wherein correcting linguistic errors comprises:
identifying and correcting misspelled terms in the natural language query;
evaluating relevance of tokens to the domain context; and
reconstructing the natural language query by either removing tokens determined to be irrelevant while preserving grammatical structure or generating a notification when no relevant tokens are identified.

9. The method of claim 1, wherein the analytical query remains in natural language format or is converted to a structured format based on implementation requirements.

10. A system for processing natural language queries, comprising:
a processor;
a vector database storing semantic model data;
a session memory module configured to maintain session data structures;
a non-transitory computer-readable medium storing instructions that, when executed, causes the processor to:
receive a natural language query from a user during a current session;
retrieve contextual information associated with the natural language query by:
applying a retrieval-augmented-generation (RAG) model to the natural language query to identify relevant metadata entities through vector computations;
accessing the session memory module to obtain related previous queries and corresponding insights from the current session;
processing, using a large language model (LLM), the natural language query based on the contextual information to generate an analytical query;
executing the analytical query against a data source to generate an analytical insight;
updating the session memory module with the natural language query and the analytical insight; and
providing the analytical insight to the user.

11. The system of claim 10, wherein the RAG model is implemented by a RAG module configured to:
tokenize the natural language query;
generate and compare vector embeddings;
compute similarity scores; and
select relevant metadata entities based on similarity thresholds.

12. The system of claim 10, wherein processing the natural language query comprises utilizing a prompt generation module configured to:
generate chain-of-thought prompts;
generate processing instructions; and
incorporate the contextual information and the processing instructions.

13. The system of claim 10, wherein processing the natural language query further comprises utilizing a query resolution module configured to:
resolve entity references;
correct linguistic errors; and
adapt a format of the natural language query for analytical processing.

14. The system of claim 10, wherein the session memory module comprises:
a query storage component configured to:
maintain chronological sequences of queries;
assign temporal identifiers to queries;
establish entity mappings between successive queries;
a reference resolution component configured to:
identify reference relationships through analysis of pronouns and contextual references;
analyze temporal relationships between queries;
an insight management component configured to:
store analytical insights;
maintain relationships between queries and corresponding insights; and
preserve contextual information utilized during insight generation.
